(19) United States
(12) Patent Application Publication
(10) Pub. No.: US 2002/0059181 A1
(43) Pub. Date: May 16, 2002

(54) Target object information provision system, terminal device, object location information provision method, object information provision system, computer program, storage medium and program transmission apparatus

(75) Inventors: Takenori Kohda, Yamato-shi (JP); Teruo Koyanagi, Yamato-shi (JP); Ken Masumitus, Yamato-shi (JP)

Correspondence Address: Robert P. Tassinari, Jr., Intellectual Property Law Dept., IBM Corporation, P.O. Box 218, Yorktown Heights, NY, 10598, US

(73) Assignee: International Business Machines Corporation, Armonk, NY (US)

(21) Appl. No.: 09/909,563

(22) Filed: Jul. 20, 2001

(30) Foreign Application Priority Data
Jul. 31, 2000 (JP) 2000 - 232306

(51) Int. Cl. G06F 7/00

(52) U.S. Cl. 707/1

(57) ABSTRACT

A target information provision system comprises: a target information manager for storing information concerning a predetermined target object present on a communication network; a radar information generator for obtaining information concerning the target object from the target information manager, and for generating radar information indicating the ease with which the target object can be reached; and a radar display unit for employing the radar information generated by the radar information generator to furnish the location of the target object.

### FIELD OF THE INVENTION

The present invention relates to a method for guiding a user to a desired network site or to its content.

### BACKGROUND ART

At present, a widely spread out network environment, such as the Internet, provides access to an enormous number of sites at which a great variety of reference materials are available. Therefore, it is vitally necessary that provisions be implemented for assisting and guiding users to specific sites, or site groupings, whereat information the users seek is available and can be accessed.

Conventionally, as a type of user guidance means, links are generally established between popular and often accessed sites (media sites) and target sites to which users are to be guided.

As a device for encouraging users to trace links, banner advertisements linked to web sites are frequently employed to attract users and arouse their interest. Thus, when a user decides that a banner advertisement is interesting and clicks on it, the user will be guided to the site to which the banner advertisement is linked.

As another user guidance means, a method is employed whereby visitors to a search site, a web portal, can be registered. A search site is a web page that provides an information search service for users. Upon the entry by a user of a keyword or words that establish a search condition, a search engine at the search site begins to search web pages to accumulate data in the form of documents whose contents match the search condition. Then, after indexing, the search results are provided to the user. Thus if a predetermined site is registered with the search site, and the search condition entered by a user matches the contents of the predetermined site, that site can be presented to the user as the search results and the user guided to it.

When a user knows the address (URL) of a target site or contents (or if the address of a target site is available through the bookmark function of the browser the user is employing) the user can move to the target site by entering the address in the browser. But if the address is not readily available, the user can still jump to the target by using links.

### PROBLEMS TO BE SOLVED BY THE INVENTION

However, a link for a jump to a target site, or contents, that permits a user to move directly to the target site is only available at the site, or the contents (currently browsed contents), the user is currently connected to. Thus, for example, when the target is within a range that can only be reached from the current site by passing through several links, or when the user has moved from the site that is linked to the target to another site, it is difficult to effectively guide the user.

For example, so long as a user does not know the location of a target, he or she can jump to the target only from a media site that is linked to the target. Therefore, when the user has moved to another site without selecting that link, and when he or she desires to move to the linking destination, first the user must return to the original media site. However, when the user has been surfing and has made several jumps to other web pages, he or she may not always remember in which site the desired link is formed. As a result, the user may not be able to link up with a desired destination.

And when the location of a target is changed, the link in the media site must be updated, and as needed, a user must be notified that the target has moved. Therefore, the manager of the target site, or contents, and the manager of the media site must expend a great deal of effort to keep link postings current.

Further, there is a case where a route for guiding users is designated so as to permit the user to move to a target site, via a link, only after he or she has browsed through specific contents. For example, when a provision is made for the awarding of a premium or a service as a prize, the intent of the provider is to present product advertisements for perusal by users, and the prize is established to attract the attention of the users. In this case, if a user jumps directly to the contents to apply for the prize, the purpose for which the prize was established can not be achieved.

For such an occasion, a specific route can be set up by connecting links. However, in this case, since the unconditional selection of sites en route is not possible, and since users can not be prevented from moving to a site by following a path that does not correspond to a specified route, the user can not always be guided along a set route.

Therefore, guiding users along a specific route is extremely difficult when the conventional user guidance method, which employs links, is used.

As is described above, since a link to a site can merely be provided for direct movement to that target site from the site, or the contents (currently browsed contents), to which a user is currently connected, with the conventional user guidance method that uses links, a flexible setup, for example, is impossible, since a target located within a range that can be reached only by tracing several links can not be provided, and a route to the target can not be specified. SUMMARY OF THE INVENTION

It is one object of the present invention to furnish information that can provide improved user convenience when moving from arbitrary current contents to a desired site or contents.

It is another object of the present invention to guide a user to a specific site group by controlling the information that is provided.

To achieve the above objects, in accordance with the present invention a target information provision system having the following configuration is provided. A target information provision system comprises: a target information manager for storing information concerning a predetermined target object present on a communication network; an information generator for obtaining information concerning the target object from the target information manager, and for generating position information indicating the ease with which the target object can be reached; and a target presenter for employing the position information generated by the information generator to furnish the location of the target object.

For a target presenter, the employment of visual means is the most effective when displaying the location of a target object; however, other means, including voice, may be used as a substitute or replacement, or as an auxiliary information dissemination method.

The information generator generates the position information concerning the target object based on the correlation between the target object and an object on a communication network from which information is acquired by a browser. The target presenter employs the position information generated by the information generator to provide a positional relationship between the target object and a current object.

The information generator calculates a distance between the target object and the current object based on a previously defined rule to specify a communication network distance, and generates position information that includes the obtained distance. The target presenter extracts the included distance from the position information and provides it as visually identified information.

Various rules can be established for specifying a distance between objects on a communication network by basing the rules on the level of the correlation between the objects, or on the ease of travel from one to the other object.

According to a typical rule, when the locations of the objects on a communication network are represented by URLs, the distance between the objects is calculated based on the perspective in the hierarchical structure for the storage locations of the files of the objects represented by the URLs. Further, the distance between the objects on the communication network can be calculated from the perspective applying to the categories of a rule for categorically arranging the objects. In addition, the connection relationship existing between links to the objects on the communication network is employed to replace, with distance values, the minimum number of hops that is required to move from a predetermined object to another object. According to this rule, the information generator obtains the distance between the target object and the current object.

According to the present invention, a terminal device having a network connection function for accessing a communication network comprises: a browser for browsing an object present on the communication network; and a display unit for visually displaying a positional relationship indicating the ease of travel from a current object browsed by a browser to a predetermined target object present on the communication network.

More specifically, the display unit obtains, from a predetermined search engine, location information for the target object on the communication network and obtains, from the browser, location information for the current object on the communication network, and employs the location information for the target object and the current object to obtain the positional relationship relative to the objects.

A search engine may be a program on a search site on a communication network, or a terminal device may function as a search engine. In the first case, the display unit accesses a search site, and obtains, from a search engine at the search site, location information for a desired object on the communication network. In the second case, the display unit obtains, from a search engine at the terminal device, location information for a desired object on the communication network.

A display unit can employ various display forms so that a user can visually identify the positional relationship of the objects. As a specific example, a mark indicating an object is displayed at specific polar coordinates with the current object at the center, so that the positional relationship of the current object and the target object can be displayed. The distance between the target object and the current object is calculated based on the previously defined rule established to specify distances on the communication network, and a numeral indicating the distance is displayed. The distance between the target object and the current object is calculated based on the previously defined rule established to specify distances on the communication network, and a graph can be displayed that shows the locus of a change in the distance between the current object and the target object.

According to the present invention, an object position information provision method having the following configuration can be provided. An object position information provision method comprises the steps of: registering, as a target object, an object that is present on a communication network and that matches a condition set by a user; using a browser to browse the object present on the communication network; and obtaining a positional relationship indicating the ease of travel from the current object to the target object, and providing information for the user describing the positional relationship.

More specifically, the step of obtaining the positional relationship of the objects and of providing information for the user describing the positional relationship includes the steps of: obtaining location information for the target object on the communication network; obtaining location information for the current object on the communication network; and calculating a distance between the target object and the current object based on the location information for the objects and a previously defined rule that is employed for specifying distances on the communication network.

According to the present invention, an object information provision system having the following configuration is provided. An object information provision system comprises: a search site located on a communication network; and a terminal device for accessing various sites, including the search site, via the communication network, and for browsing objects managed by the sites, whereat, upon the receipt of a request from the terminal device, the search site returns, to the terminal device, location information for a predetermined site or object on the communication network, and whereat the terminal device employs the location information for the predetermined site or the object received from the search site to submit a positional relationship indicating the ease of travel from a current object to the predetermined site or object.

The search site returns, to the terminal device, location information for a site or an object that is present on the communication network and that matches a previously established condition.

The terminal device transmits, with the request, location information for the current object on the communication network. The search site returns, to the terminal device, location information for a site or an object on the communication network, so that the distance on the communication network, between the site or object and the current object received from the terminal device, that is defined in accordance with a specific rule is equal to or smaller than a previously established value.

According to the present invention, a computer program is provided that permits a computer to perform: a process for obtaining location information for a predetermined target object on a communication network; and a process for employing the location information for the target object to generate information enabling the visual display of a positional relationship indicating the ease of travel from a current object to a target object. Further, a storage medium is provided on which this program is stored so that this program can be read by input means of a computer.

Furthermore, according to the present invention, a program transmission apparatus comprises: storage means for storing the program; and transmission means for reading the program from the storage means and for transmitting the program.

### BRIEF DESCRIPTION OF THE DRAWING

FIG. 1 is a diagram for explaining the configuration of a target information provision system according to one embodiment of the present invention.

FIG. 2 is a flowchart for explaining the general processing performed by the target information provision system in FIG. 1.

FIG. 3 is a flowchart for explaining the processing performed by a current URL manager according to the embodiment.

FIG. 4 is a flowchart for explaining the operation of a radar information generator according to the embodiment.

FIG. 5 is a flowchart for explaining the operation of a target information manager according to the embodiment.

FIG. 6 is a diagram for explaining the distance between URLs that are defined by using the URL structure according to the embodiment.

FIG. 7 is a diagram for explaining the distance between URLs that are defined according to the embodiment by the conceptual hierarchical structure that represents web sites that have been sorted by category.

FIG. 8 is a diagram for explaining the distance between URLs that are defined by using hyperlinks for web pages at a predetermined web site according to the embodiment.

FIG. 9 is a diagram showing an example configuration for a radar that employs a polar coordinate system according to the embodiment.

FIG. 10 is a diagram showing an example format for radar information generated by the radar information generator to present using the radar in FIG. 9.

FIG. 11 is a diagram showing an example structure for a radar according to the embodiment that uses numerals.

FIG. 12 is a diagram showing another example format for the radar information generated by the radar information generator to describe use of the radar in FIG. 11.

FIG. 13 is a diagram showing another example structure of a radar according to the embodiment that uses a graph.

FIG. 14 is a diagram showing an additional example structure of a radar according to the embodiment that uses a list.

FIG. 15 is a diagram showing an additional example format for the radar information generated by the radar information generator to describe use of the radar in FIG. 14.

FIG. 16 is a diagram showing an example display for a radar when the embodiment is applied for a registered site approach notification system.

FIG. 17 is a diagram for explaining the network configuration for implementing a user guidance system according to the embodiment that uses a moving object.

FIG. 18 is a diagram for an explanation, based on a typical example, of the concept of the user guidance system according to the embodiment that uses the moving object.

FIG. 19 is a diagram showing the arrangement wherein a zero distance performer is added to the target information provision system in FIG. 1.

FIG. 20 is a flowchart for explaining the processing performed by the zero distance performer in FIG. 19.

### DETAILED DESCRIPTION OF A PREFERRED EMBODIMENT

The preferred embodiments of the present invention will now be described while referring to the accompanying drawings.

An overview of the present invention will now be given. In this invention, the positional relationship between a current site (the contents of which a user is presently browsing) and a specific target site or contents are provided for the user. This positional relationship includes a case wherein several hops between intervening links are required to travel from the current contents to the source of the target contents.

The target site or contents include not only the site or the contents that the user intends to directly browse, but also a site or contents that the user may browse when so inclined (or if the opportunity arises). Specifically, the target site or contents can be a site or contents corresponding to the hobby of the user, information that was previously elicited, a site or contents that, as defined, offer to provide a benefit, such as a prize or a service, for a user and thus induce the user to browse the site or the contents, or a site or contents that include an object that is so defined that the user will search for it in accordance with a specific rule. That is, a site or contents that can provide some benefit for a user can be widely and flexibly set as a target.

Therefore when a site or contents that provide a benefit for a user are present near (at a location that can be reached by transiting several links) arbitrary contents that a user is currently browsing, the user can ascertain that the target is present near the current contents. Therefore, the opportunities for the user to browse the target site or contents are increased. Further, when a target site or contents are controlled, a user can be guided along a specific route or in performing hops in a specific order so as to trace a route to a specific site, or so as to browse a site or contents located near a specific site.

According to the invention, radar is one means that is employed to describe the positional relationship between current contents and a target site or contents. As a tool, radar is not used for providing the location of a target, but is used for providing data that is employed to prepare an image that a user visually apprehends representing the distance to the target. When the user refers to the radar display while browsing the content of an arbitrary site, the user can identify that the target is present close to the current content, and how the traveling route of the user is positioned relative to the target.

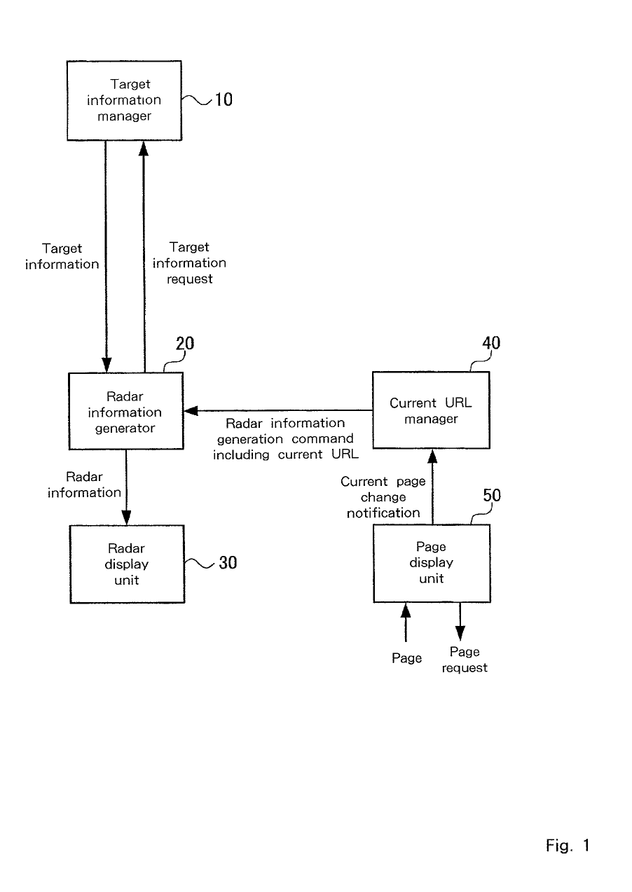

FIG. 1 is a diagram for explaining the configuration of a target information provision system according to one embodiment of the invention. In this embodiment, a web-based network, such as the Internet, is employed. Therefore, sites in this embodiment are mainly web sites, and contents are mainly web pages. The location of a site or of content can be specified by using a URL. It should be noted that this embodiment can also be applied for another network that does not employ the web technique.

In FIG. 1, a target information manager 10 manages information concerning the location of a target site or contents on a communication network. A radar information generator 20 generates radar information concerning the target that is provided for a user by radar. The radar information is source data indicating the positional relationship existing between the target contents and contents that the user, while employing the user terminal, is currently browsing. A radar display unit 30 displays, on the user terminal, a radar produced image using radar information that is generated by the radar information generator 20. A current URL manager 40 manages the URL of the current contents (web page). And a page display unit 50 displays the contents on the user terminal.

With this configuration, the radar display unit 30, the current URL manager 40 and the page display unit 50 are provided for the user terminal. Actually, the page display unit 50 is implemented by the web browser, and the radar display unit 30 and the current URL manager 40 are mounted as functions of the web browser by using plug-ins. The target information manager 10 and the radar information generator 20 can be mounted in the user terminal or in a server that provides target information as a service.

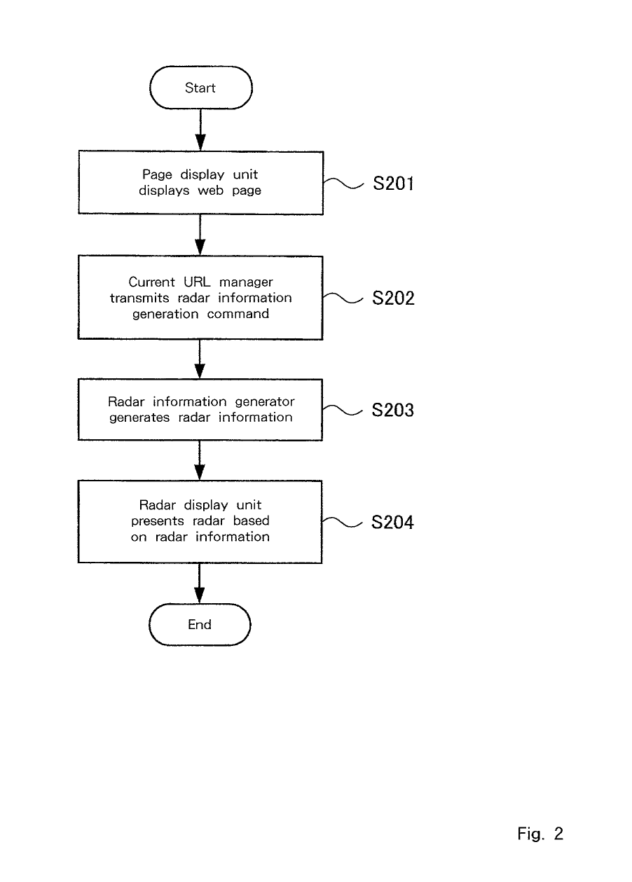

FIG. 2 is a flowchart for explaining the general processing performed by the target information provision system in FIG. 1. In FIG. 2, first, a user displays, on the page display unit 50 of the user terminal, a web page obtained from a predetermined web site (step 201). When the web page is displayed on the page display unit 50, the current URL is transmitted from the page display unit 50 to the current URL manager 40. This process is performed each time the page display unit 50 updates the display of the web page.

The current URL manager 40 transmits, to the radar information generator 20, the URL of the current web page displayed by the page display unit 50 and a command for the generation of radar information that relates to the current location of a predetermined target (step 202). The radar information generator 20 then generates the radar information, based on the URL that is received with the radar information generation command (step 203). The generated radar information is thereafter reflected, by the user terminal, in the radar display prepared by the radar display unit 30 (step 204).

The processes performed by the respective functional blocks will now be descried in detail.

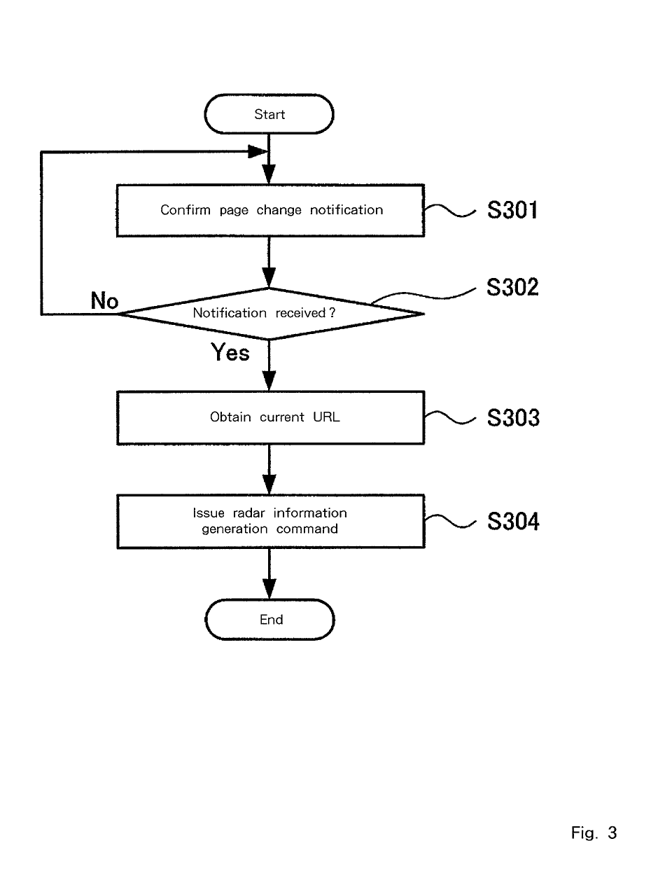

FIG. 3 is a flowchart for explaining the processing performed by the current URL manager 40 at step 202 in FIG. 2. In FIG. 3, first, the current URL manager 40 receives, from the page display unit 50, a web page change notification (steps 301 and 302), and obtains from the notification the URL of a web page that is newly being browsed (step 303). Then, the current URL manager 40 issues a command to the radar information generator 20 for the generation of radar information (step 304).

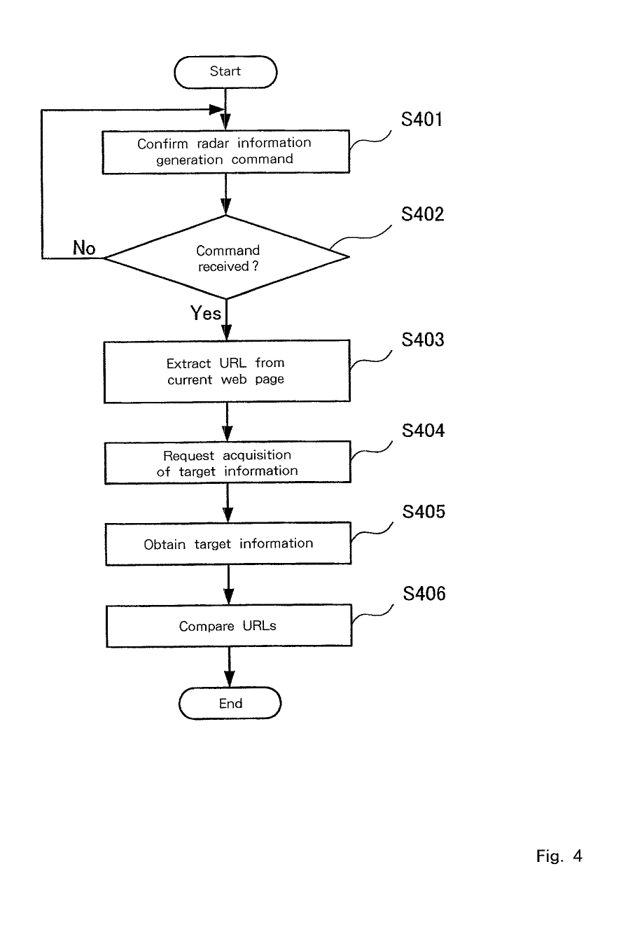

FIG. 4 is a flowchart for explaining the processing performed by the radar information generator 20 at step 203 in FIG. 2. In FIG. 4, first, the radar information generator 20 receives the radar information generation command from the current URL manager 40 (steps 401 and 402), and extracts a new current URL from the command (step 403).

The radar information generator 20 transmits, to the target information manager 10, a request for the acquisition of the URL for the target site or contents (step 404), and the URL of the target site or contents are obtained (step 405). The current URL obtained at step 403 is compared with the target URL obtained at step 405, and the distance between the two URLs is examined (step 406). How to define the distance between the two URLs will be described later.

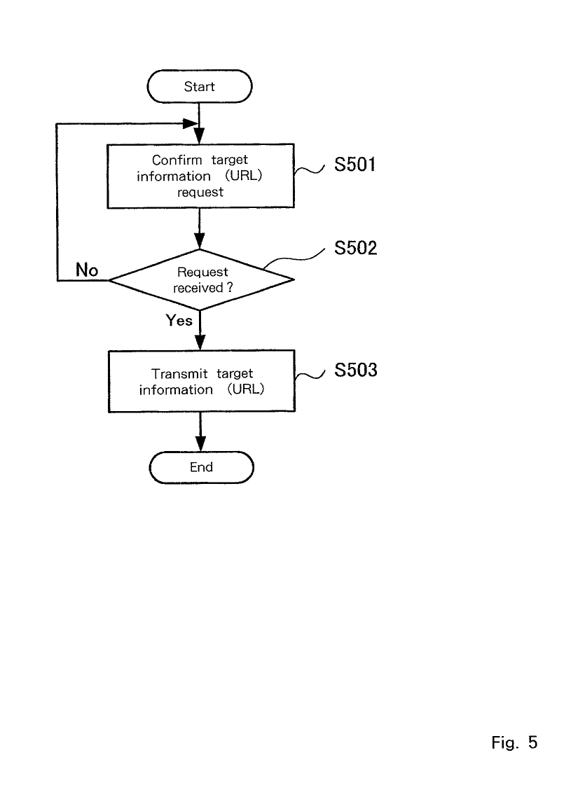

FIG. 5 is a flowchart for explaining the processing performed by the target information manager 10. In FIG. 5, the target information manager 10 receives, from the radar information generator 20, a request for the acquisition of the URL of a target site or contents (steps 501 and 502), and the target URL is returned to the radar information generator 20, which is the request transmission source (step 503).

An explanation will now be given for the radar displayed on the user terminal by the radar display unit 30. The radar presents the distance from the current web page to the target site or contents using a graphic form that a user can visually apprehend. The distance between the current web page and the target (distance between the current URL and the URL of the target site or the contents) is not a physical distance, but is a numerical value that represents the ease with which a transfer from the current web page to the target can be effected. Therefore, when the distance between the current web page and the target is short, a specific correlation is established between the two. Various methods can be used to define this distance. An explanation will now be given for the definitions used for several distances and the method for calculating the distances.

First, the definition of the distance between the URLs, for which the URL structure is used, will be described. Since a site name and a file name are described as a URL, in accordance with the hierarchical structure of the storage locations of files, the distance can be defined based on the perspective of the hierarchical structure as indicated by the URLs.

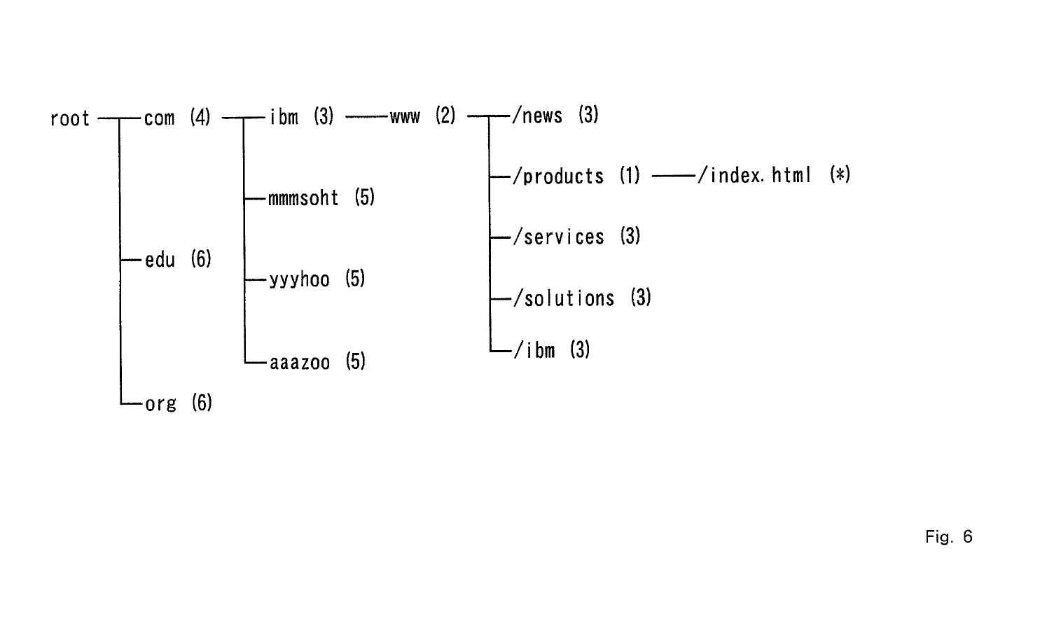

FIG. 6 is a diagram for explaining the distance between defined URLs by using the structures of the URLS. In FIG. 6, the hierarchical structure of the storage locations of files indicated by the URLs is expressed as a tree structure. In FIG. 6, the URL to which an asterisk (*) is appended is the URL of the target contents (web page). And the numbers added to nodes indicate the distances to the target contents. For example, since “com.ibm.www/products” can be reached by tracing one branch from “com.ibm.www/products/index.html”, the distance is “1”. Similarly, since “com.ibm.www” can be reached by tracing two branches, the distance is “2”. Further, since “com.ibm.www/news” and “com.ibm.www/services”, which are at the same level as “com.ibm.www/products”, can be reached by tracking three branches, the distance is “3”.

Therefore, when the contents having the URL “http://www.com.ibm.www/services” are displayed by the page display unit 50 of the user terminal, the radar indicates that the distance to the target is “3”.

An explanation will now be given for the definition of the distance to the URLs using the conceptual hierarchical structure of a web site. The distance can be defined by using the perspective applied to the sorting of web sites into categories that employ a search engine.

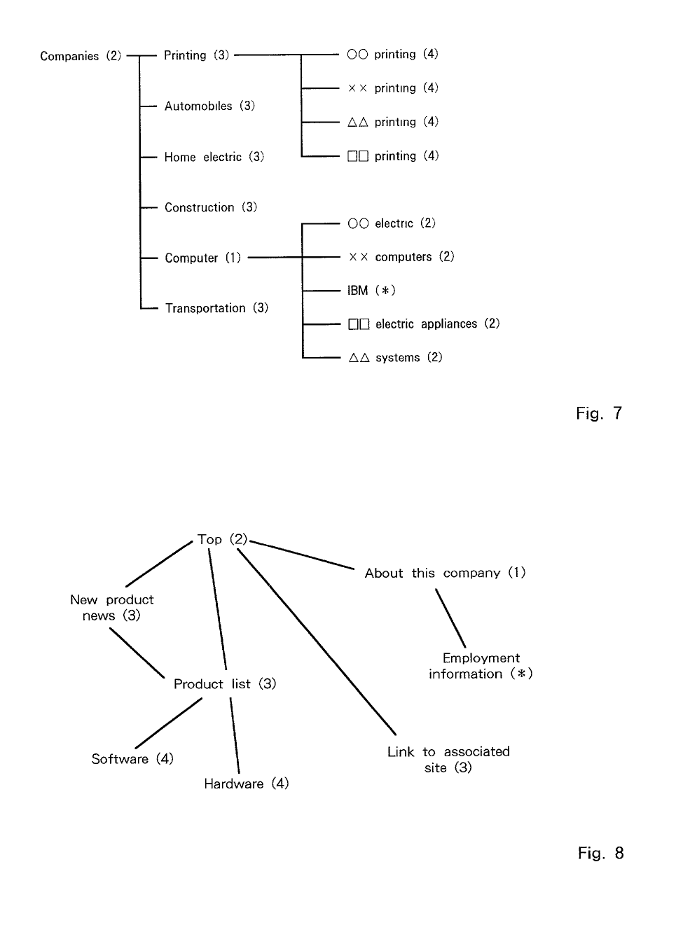

FIG. 7 is a diagram for explaining the distances between URLs that are defined by using the conceptual hierarchical structure, in which the sorting of web sites is represented by categories. In FIG. 7, the hierarchical structure of the categories is expressed as a tree structure. In FIG. 7, the URL to which an asterisk (*) is appended is the one for the target site. The numbers added to nodes represent the distances from the target site. For example, since the category “computers” of “companies” can be reached by tracing one branch from “IBM” that is sorted into “computers”, the distance is “1”. Similarly, since “οο Electric” and “XX Computer”, which are at the same level as “IBM”, can be reached by tracing two branches, the distance is “2”. Further, since “ΔΔ Printing” of category “Printing” can be reached by tracing four branches, the distance is “4”. Therefore, when the content of the site “οο Electric” is displayed by the page display unit 50 of the user terminal, the radar presents the display that indicates the distance to the target is “2”.

An explanation will now be given for the definition of the distance between the URLs based on the connection relationship of the hyperlinks of the web pages. The user terminal that is browsing a predetermined web page can jump (move) to another web page along the current hyperlink. Therefore, the number of jumps required for moving from the current web page to the target site or content can be defined as the distance between those web pages.

FIG. 8 is a diagram for explaining the distances between the URLs defined by using the hyperlinks for the web pages at a predetermine site. In FIG. 8, the connection relationship of the hyperlinks for multiple web pages is shown. In FIG. 8, the URL to which an asterisk (*) is appended is the one for the target site or content. The numbers added to nodes indicate distances from the target. Since the web page, “about this company”, can be reached in one hop from web page “employment information”, the distance is “1”. Similarly, since “new product News” and “product list” can be reached by three hops, the distance is “3”. Further, since three hops are required to move to another associated site, the distance to web page “employment information” is obtained by adding three to the number of hops that is required to reach this site from the associated site shown in FIG. 8. Therefore, when the web page “new product News” is displayed by the page display unit 50 of the user terminal, the radar presents the display indicating that the distance to the target is “3”.

In addition to the structural information, such as the URL structure, the sorting of web pages and the connection relationship of the web pages, the descriptions of the URLs can be compared to define the distance between the URL of a predetermined web page and the URL of the target site or contents. For example, the two URLs are compared, and the number of different characters between two URLs can be defined as the distance between the two. That is, when

(1) http://www.ibm.com/news/index.html and

(2) http://www.ibm.co.jp/news/index.html are compared, three characters are different between “com” in (1) and “co.jp” in (2). Thus, the distance between the URLs can be defined as “3”. Further, the distance can be set in accordance with how many specific keywords (character strings) are included in a URL.

In addition, in accordance with the physical connections of a network, the response time for the network to the target site or the number of computers that pass through the target site, may be employed.

An explanation will now be given for the expression form of the radar that is generated based on the distance between the URLs defined using these methods.

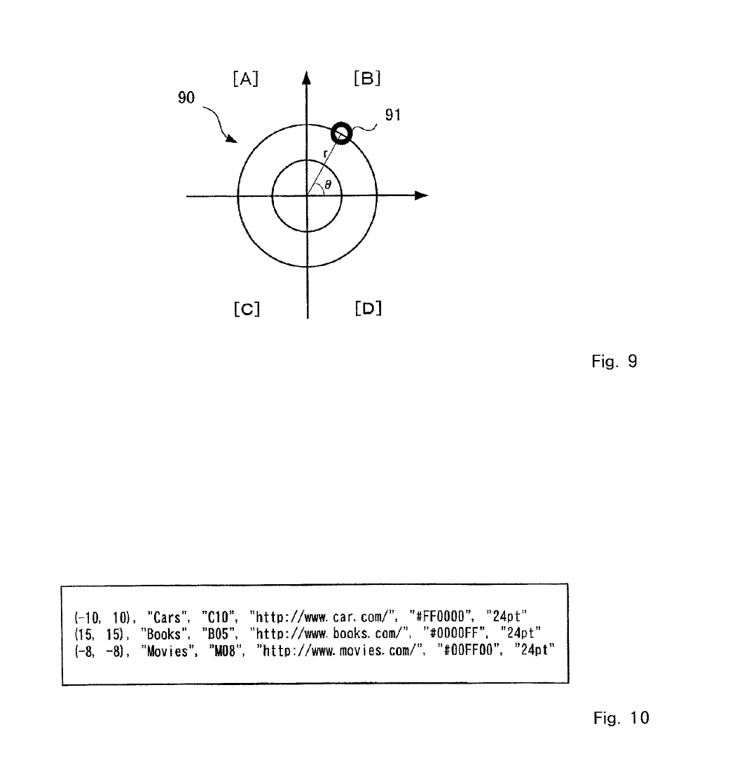

FIG. 9 is a diagram showing an example for the radar. In FIG. 9, a radar 90 employs polar coordinates to schematically display the position of a target 91 relative to a current web page. That is, with the current web page acting as the origin, the position of the target 91 is represented by the parameters (r, θ). The parameter r depicts the distance between the current web page and the target 91, and the parameter θ is set in accordance with the tastes of the user and the target 91 type. When the parameters are actually used, the parameter θ need not be specifically set. That is, the coordinate system is divided into several fan-shaped regions that are allocated in accordance with, for example, the hobbies of the users, and then, a mark representing the target 91 is displayed in an appropriate region in accordance with the type of web site or web page that is the target 91.

A specific example will now be given. In FIG. 9, the hobbies of a user are allocated to four areas [A], [B], [C] and [D]. For example, cars are allocated to area [A], personal computers (hardware) are allocated to area [B], traveling is allocated to area [C] and fishing is allocated to area [D]. Assume that the inner circle of the polar coordinate is defined as distance 1 and the outer circle is distance 2, and that the distance is defined based on the connection relationship between the hyperlinks. In this case, it is found that the target 91 includes the contents concerning personal computers, and is located at distance 2 from the current web page (location that can be reached by two hops using the links).

The distance to the target 91 to be presented by the radar 90 can be set depending on the target type (contents). For example, a predetermined target 91 type is displayed on the radar 90 when it is located at distance 5 from the current web page (a location that can be reached by five clicks), and another predetermined target 91 type is presented by the radar 90 when it is located at distance I from the current web page. In this manner, the range within which a search for the target 91 is to be performed can be set, depending on the target 91 type. The radar information generator 20 can control this setting.

FIG. 10 is a diagram showing an example format for the radar information generated by the radar information generator 20 in order to present the radar 90 in FIG. 9. The radar information in FIG. 10 includes, from the beginning, the current coordinates, the title, the object ID, the URL, the display color, and the display font size. Based on these data, the target 91 is presented at a predetermined location on the radar 90 using a predetermined display color and size.

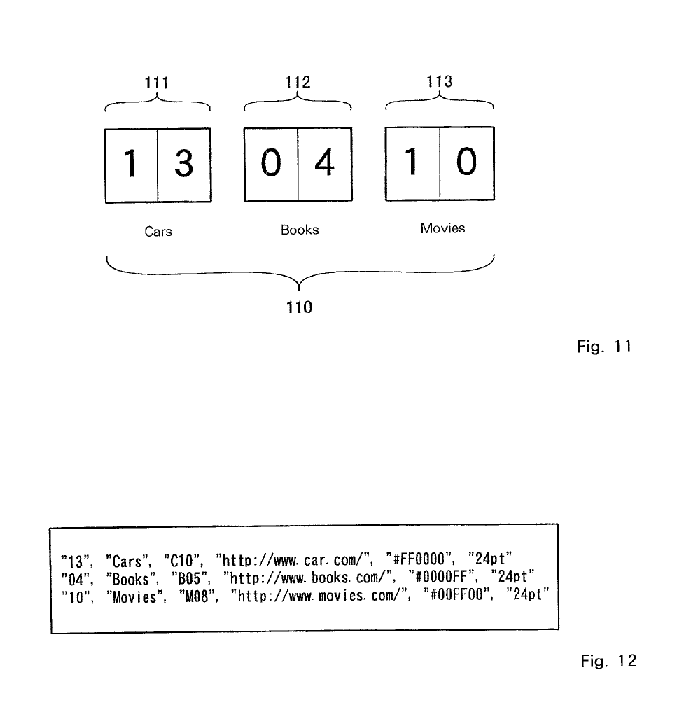

FIG. 11 is a diagram showing another example radar structure. A radar 110 employs numerical values to represent the distance between the current web page and the target. Multiple numerical values can be displayed in accordance with the target category, such as the hobby of the user or the site offering a prize.

In the example in FIG. 11, the distance to the contents (target), which includes information concerning cars, is presented in a display portion 111, the distance to the contents (target), which includes information concerning the introduction of books, is presented in a display portion 112, and the distance to the contents (target), which include information concerning the introduction of movies, is displayed in a display portion 113. Therefore, when the distance is defined based on the hyperlink connections, it is found, for example, that the contents, including the information concerning the introduction of books is located at distance 4 from the current web page (a location that can be reached by four hops using the links).

FIG. 12 is a diagram showing an example format for the radar information generated by the radar information generator 20 to display the radar 110 in FIG. 11. The radar information shown in FIG. 12 includes, from the beginning, the distance, the title, the object ID, the URL, the display color, and the display font size. Based on these data, a number indicating the distance to the target is displayed using a predetermined display color and font size.

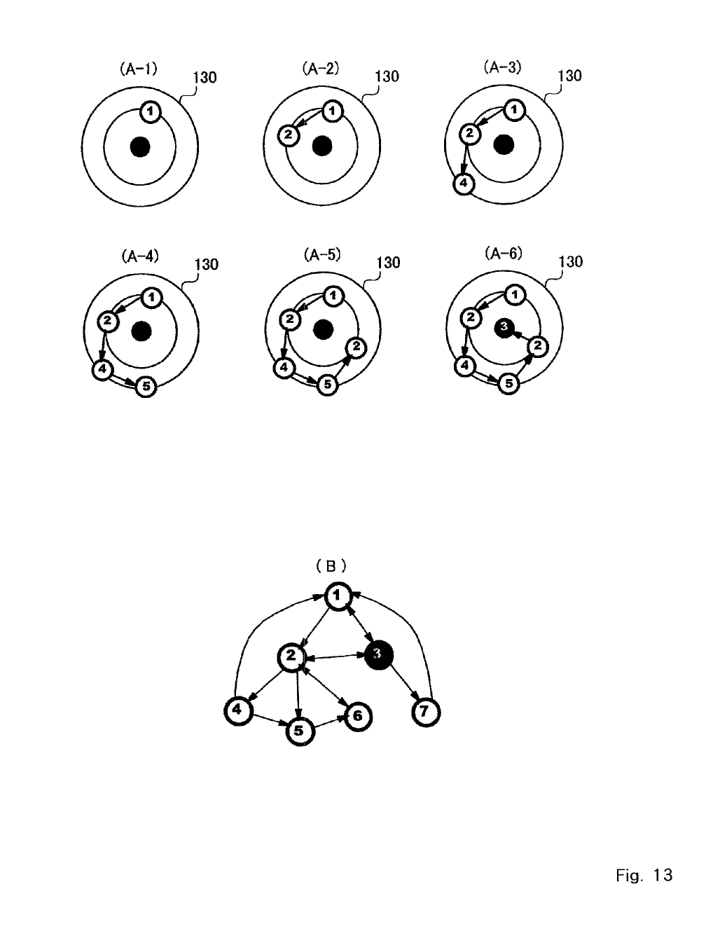

FIG. 13 is a diagram showing another structure for a radar. A radar 130 employs the browsing history of the web page to display a graph that shows the locus of a change in the distance to the target. (A-1) to (A-6) in FIG. 13 are example displays when the contents at node 3 constitute the target at the site having the hyperlink structure shown in FIG. 13(B), and when the links are tracked in the order of nodes, 1, 2, 4, 5, 2 and 3. The concentric circles represent the distances to the target, the inner circle defining distance 1 and the outer circle defining distance 2.

While referring to (A-1) to (A-6) in FIG. 13, it is found that, when the contents at node 1 are browsed by the user terminal, the distance to the contents at target node 3 is 1, i.e., the target node 3 can be reached by one hop (A-1) in FIG. 13). When a hop is made from the contents at node 1 to the contents at node 2, the distance from the contents at node 1 to the contents at node 2 is also 1, so that the indicator travels along the inner circle on the radar 130 (FIG. 13 (A-2)). When a hop is made from the contents at node 2 to the contents at node 4, the distance from the contents at node 4 to the contents at node 3 is 2, so that the indicator is shifted to the outer circle on the radar 130 (FIG. 13(A-3). Similarly, when a hop is made from the contents at node 4 to the contents at node 5, the indicator travels along the outer circle on the radar 130 (FIG. 13(A-4)). Then, when a hop is made from the contents at node 5 to the contents at node 2, the indicator is shifted from the outer circle to the inner circle on the radar 130 (FIG. 13(A-5)). Finally, when a hop is made from the contents at node 2 to the contents at node 3, it is found that the user has reached the target (FIG. 13(A-6)). On the radar 130, the distance traveled along the circle (the travel angle to the target at the center) can be arbitrarily set. If the indicator on the radar 130 is moved all around without easily reaching the target, only the number of hops for displaying the locus at one time need be determined in advance, and the locus must be deleted in order, beginning at the oldest.

Since the radar 130 only presents the distance to the target, the radar information (see FIG. 12) having the same format as that used for the radar 110 can be employed. Further, as well as for the radar 110 in FIG. 11, multiple radars 130 can be presented in accordance with the category of the target.

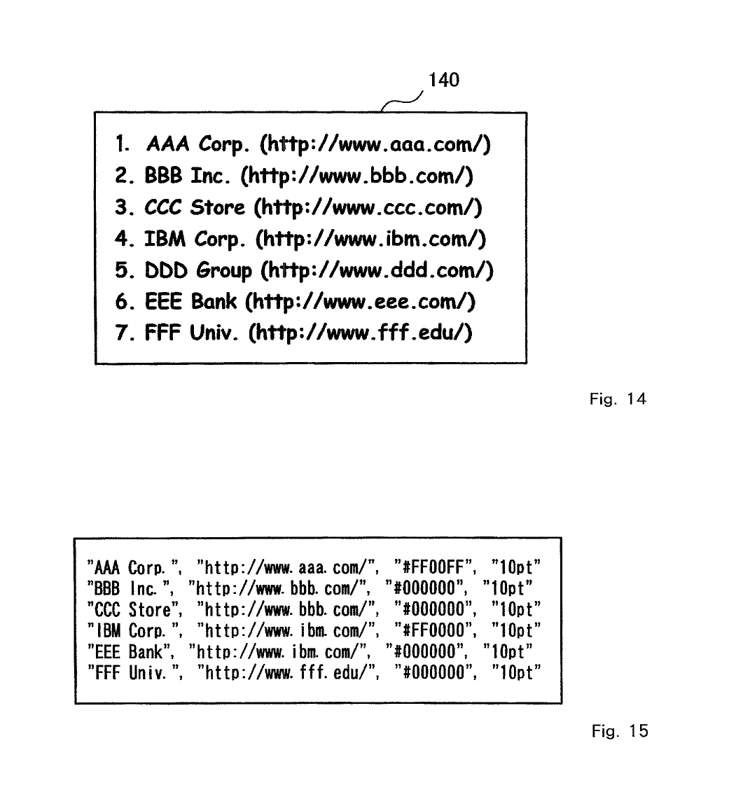

FIG. 14 is a diagram showing an additional example structure for a radar. A radar 140 presents a list of sites whereat a target is located. In this list, the display color of a web site on the list may be changed in accordance with the distance between the current web page and a target web site, so that notification of the distance can be conveyed to a user. Further, the mouse may be clicked on the URL on the list, so that a hop is made from current site to the target site. When the user is present at an arbitrary site, the distance between the current web page and the target site or contents may be enormous, depending on the distance definition method used. In this case, the radar may present the list, and after a hop is made from the current site directly to the target site, or the site whereat the target contents are located, the radar may present the form shown in FIG. 9, 11 or 13.

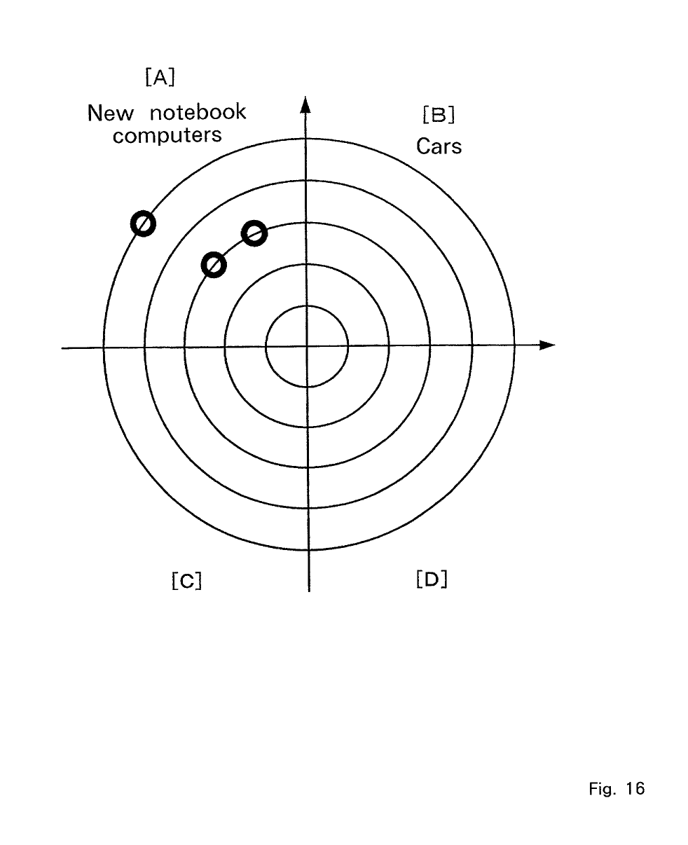

FIG. 15 is a diagram showing an example format for the radar information generated by the radar information generator 20 to present the radar 140 in FIG. 14. The radar information in FIG. 15 includes, from the beginning, the title, the URL, the display color, and the display font size. Based on these data, the target site, or the site whereat the target contents are located, and its URL are presented by the radar 140 using a predetermined display color and font size.

In the above configuration, the radar display unit 30 has been used as the target presentation unit for presenting the target to the user, and the distance between the current web page and the target site or contents has been represented using visual means, i.e., a radar. However, the means other than visual means (e.g., speech) may be employed to notify the user that the target is within a specific distance, or has been reached. Visual means, like radar, and other means may be employed together to draw the attention of the user.

A target information provision system according to the embodiment will now be described. In this example, an explanation will be given for a registered site approach notification system for detecting when a predetermined site, or contents, is approached and for, when a user is browsing an arbitrary web page while surfing, providing the user information to that effect using a radar, and for a user guidance system for permitting a target object to appear among a predetermined site group so that a user finds it, while permitting the user to search for the target object and at the same time using the radar to guide the user to a specific site or contents.

Registered site approach notification system

In this system, the condition of a target site or contents (hereinafter referred to as a target condition) is registered in advance in the target information manager 10 in accordance with the hobby or the needs of a user. When the user is browsing an arbitrary web page while surfing, and when a site or contents that match the target condition is located at some distance from the current web page, the pertinent site or contents are displayed as a target on the radar.

An explanation will be given for a registered site approach notification system to which the target information provision system in FIG. 1 is employed. In this case, the target information manager 10 can be implemented by a search engine. Specifically, a keyword referring to a target site or to contents, for which a user desires to acquire position information (radar information), is supplied to the search engine, the target information manager 10. The search engine obtains the URLs for sites or web pages to be included in the search list, and identifies a site or a web page as a target when the keyword is detected. When the target is near the user while the user is browsing an arbitrary web page, the radar information generator 20 obtains the position information for the target from the search engine, generates the radar information and transmits it to the radar display unit 30.

A predetermined search site may be employed as the search engine, or a search engine function may be provided for the user terminal. When the search site that sorts the search lists in accordance with categories is employed, the sorted categories can be employed to define the distance between the site and the contents. When the search engine function is provided for the user terminal, it is preferable that the search engine operates in the background, so that a high-level processing capacity is required for the user terminal. When the search engine function is effectively conducted, it is preferable that the user terminal be constantly connected to the communication network.

Further, when a main server is provided that establishes a contract for the provision of the information contained in the contents for a predetermined site group and for managing information contained in the contents and at the URL, the main server can be used as the target information manager 10. In this case, the user terminal accesses the communication network via the main server, which is the target information manager 10, and the main server provides the information concerning the location of the target contents

When the search engine at the search site or the main server is employed as the target information manager 10, the radar information generator 20 can be provided, along with the target information manager 10, for the search site or the main server. With this arrangement, the radar information of the target generated by the radar information generator 20 is transmitted to the user terminal unchanged either by the search site or the main server. When the target information manager 10 is present at the search site or the main server and the radar information generator 20 are provided for the user terminal, the user terminal issues a request to the search site or the main server to obtain the target URL required for the generation of radar information. Then, the radar information generator 20 generates the radar information based on the received URL, and the radar display unit 30 employs the generated radar information to present the radar. When the search engine provided for the user terminal is employed as the target information manager 10, the radar information generator 20 is provided for the user terminal. Thus, by using one of its own functions, the user terminal can obtain the URL of the target site or contents from among various sites or contents on the communication network, generate the radar information, and present the radar.

The radar display unit 30, the current URL manager 40 and the page display unit 50 are provided as a web browser and its functions for the user terminal. When the radar information generator 20 is provided for the search site or the main server, the radar display unit 30 receives the radar information from the search site or the main server, and presents the radar based on the radar information. When the radar information generator 20 is provided for the user terminal, the radar is presented based on the radar information generated by the radar information generator 20 of the user terminal.

An explanation will now be given for a specific example when the embodiment is applied for the registered site approach notification system. In this example, the search engine at the search site is employed as the target information manager 10, and the radar information generator 20 is provided for the server at the search site. The radar display unit 30 displays the radar 90 using the polar coordinates shown in FIG. 9.

In the registered site approach notification system, when a user employs the user terminal to browse an arbitrary web page, the current URL manager 40, which identifies the web page on the page display unit 50, obtains the URL of the web page and requests that the radar information generator 20 at the search site generate the radar information.

Upon the receipt of the request, the radar information generator 20 obtains the target URL from the search engine, which is the target information manager 10, and generates the radar information. At this time, the keyword is furnished the target information manager 10 by the user in order to define target web pages concerning a new notebook personal computer and cars. Further, the radar is set as follows. When the distance between the current web page and the web page (hereinafter referred to as a target (new product)) concerning a new notebook personal computer is 5, the pertinent web page is presented using the radar. When the distance between the current web page and the web page (hereinafter referred to as a target (cars)) concerning the cars is 2, the pertinent web page is displayed on the radar.

Under the above condition, the radar information generator 20 transmits, to the target information manager 10, the URL received from the current URL manager 40. Based on the URL, the target information manager 10 returns, to the radar information generator 20, the URL of the target (new product) present within a distance 5 of the current web page, and the URL of the target (cars) present within distance 2. The radar information generator 20 generates the radar information based on the URL received from the target information manager 10, and returns the radar information to the user terminal.

The radar display unit 30 of the user terminal presents the radar based on the radar information received from the search site. Thus, the target (new product) present within distance 5 of the current web page and the target (cars) within distance 2 are shown on the radar.

FIG. 16 is a diagram showing a display for a radar. In the example, three targets (new products) are present within distance 5 (one at distance 5 and two at distance 2), and no targets (cars) are present within distance 2.

As is described above, when the target information provision system of the embodiment is applied for the registered site approach notification system, a user, even when not searching for interesting contents, can determine whether predetermined information is located nearby, all the while browsing an arbitrary web page. When the target information is displayed on the radar at a different distance depending on the information type, the information to be obtained can be weighted. In the above example, a target for the notebook computers is displayed on the radar when the contents are present within a wide range of distance 5, so that the information is easily obtained. A target for the cars is presented on the radar only when the contents are present within a comparatively small range of distance 2. This setting is appropriate for usage when the user browses the pertinent web page because it is near the current page.

In the above example, the radar information generator 20 obtains the position information for the target from the target information manager 10, and the radar information concerning the target is generated when the distance between the current web page and the target is equal to or smaller than a previously set value. However, the radar information generator 20 may transmit the position information for the current web page to the target information manager 10, and based on the position information for the web page, the target information manager 10 may return, to the radar information generator 20, only the position information for a target located within a specific distance that has been set in advance.

User guidance system

In this system, an object (hereinafter referred to as a moving object) is set that moves within a specific site group. The radar of the target information provision system of the embodiment is employed to search for a moving object as a target. When a user searches for the moving object, the user is permitted to visit many sites in the site group, regardless of whether he or she is interested in the site. The motivation for searching for the moving object can be provided by offering a benefit for the finder.

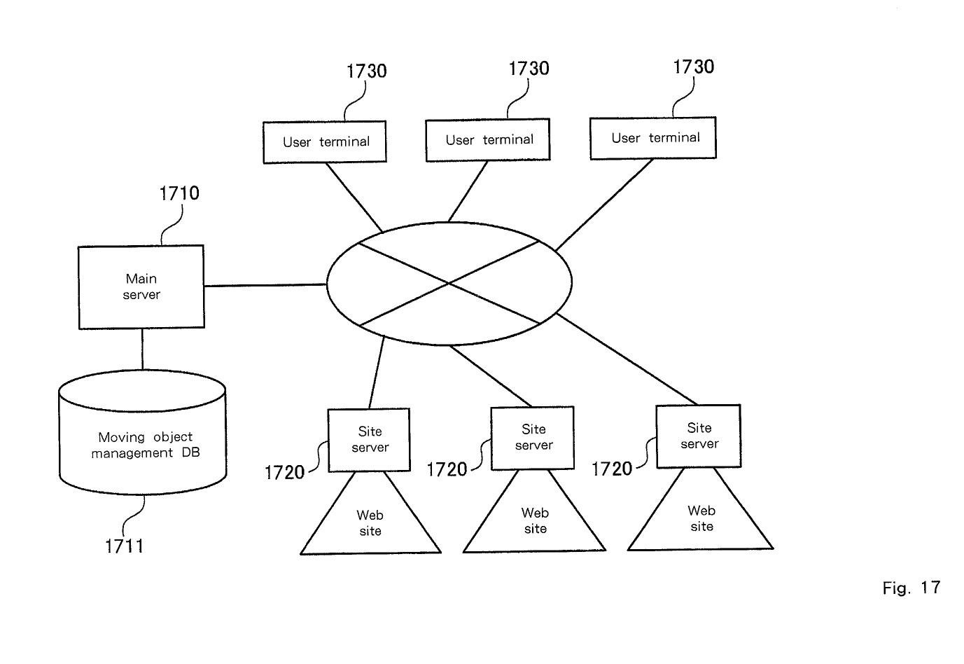

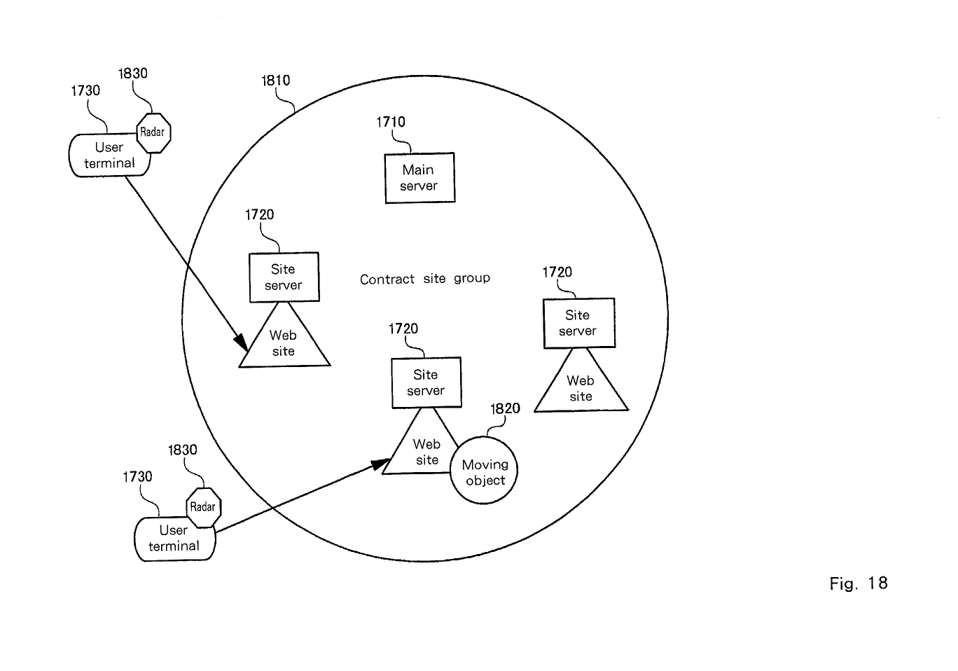

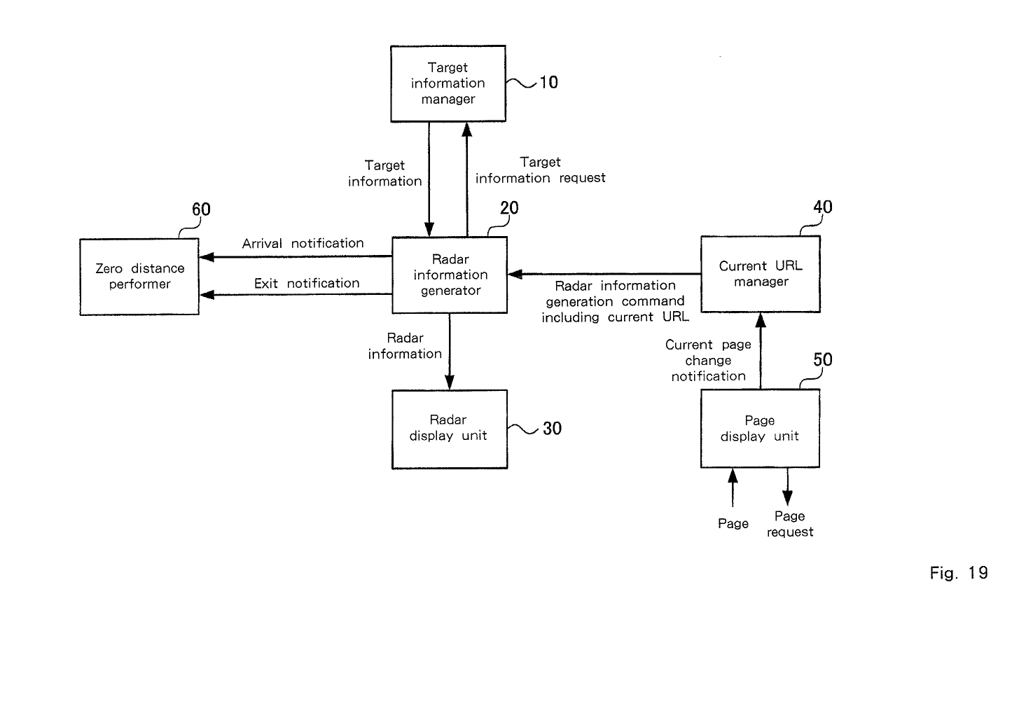

FIG. 17 is a diagram for explaining a network configuration for which a user guidance system according to the present invention is employed, and FIG. 18 is a diagram for explaining the concept of the invention based on the embodiments. In FIG. 17, a main server 1710 exercises overall control of the system. A moving object management database (DB) 1711 is used to store, under the control of the main server 1710, the location of the moving object and information as to whether a specified user has found the moving object. Site servers 1720 manage web sites that store various web pages, and as is shown in FIG. 17, the main server 1710, the site servers 1720 and user terminals 1703 are interconnected via a communication network.

As is shown in FIG. 18, according to the present invention, a contract site group 1810 is formed of web sites managed by site servers 1720 that have agreed to enter into a contract for the use of the moving object. Then, during operation, a moving object 1820, appears at a web site in the contract site group 1810, which is managed by the main server 1710. Thereafter, the user employs a radar 1830 mounted at the user terminal 1730 to search for the moving object 1820. When a specific user finds the moving object 1820, information concerning that user is stored in the moving object management database 1711, and a special reward, established in advance, is awarded that user. Each time a moving object 1820 is located, it is moved to another web site in the contract site group 1810.

An explanation will be given for a user guidance system having the following configuration and for which the target information provision system in FIG. 1 is applied. In this case, the target information manager 10 can be implemented by the main server 1710, which manages the moving object 1820. That is, since the main server 1710 includes information concerning the contents whereat the target moving object 1820 should appear in the contract site group 1810, the radar information generator 20 can obtain this information and generate the radar information.

The radar information generator 20 may be provided either for the main server 1710 with the target information manager 10, or for the user terminal 1730. In the first case, the radar display unit 30 of the user terminal 1730 presents the radar based on the radar information received from the main server 1710. In the second case, the radar information generator 20 obtains the position information (URL) for the target moving object 1820 from the main server 1710, and generates the radar information.

As is described above, the radar display unit 30, the current URL manager 40 and the page display unit 50 are provided as the web browser and the functions for the user terminal 1730. When the radar information generator 20 is provided for the main server 1710, the radar display unit 30 receives the radar information from the main server 1710, and presents the radar based on the radar information. When the radar information generator 20 is provided for the user terminal 1730, the radar is presented based on the radar information generated by the radar information generator 20 of the user terminal 1730.

The user guidance system permits searching for the moving object 1820 that appears in the contracted site group 1810. Therefore, when a specific user finds the moving object 1820, necessary processes should be performed; for example, the moving object is identified, the information concerning the discoverer is managed, and the moving object 1820 is moved to another location. When a specific user reaches contents whereat the moving object 1820 is present, a zero distance performer that performs various processes that accompany the discovery of the moving object 1820 is added to the structure of the target information provision system in FIG. 1.

FIG. 19 is a diagram showing the configuration wherein the zero distance performer is added to the target information provision system in FIG. 1. In FIG. 19, the zero distance performer 60 receives, from the radar information generator 20, an arrival notification indicating that the page display unit 50 is displaying the web page of the moving object, a detection event indicating that the moving object has been found, or an exit notification indicating that the user has exited the web page without finding the moving object. The zero distance performer 60 then performs predetermined processing. It should be noted that the page display unit 50 receives the web page from a predetermined site via the zero distance performer 60. Thus, the process whereat the zero distance performer 60 displays the moving object on the current web page on the page display unit 50 can be performed.

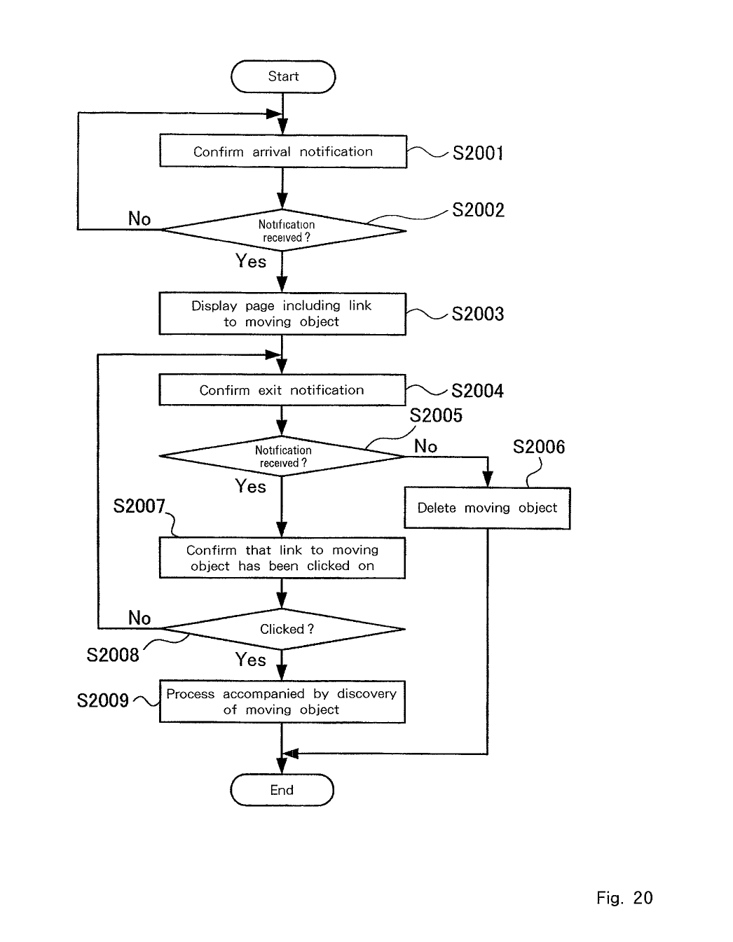

FIG. 20 is a flowchart for explaining the processing performed by the zero distance performer 60. In FIG. 20, the zero distance performer 60 receives an arrival notification from the radar information generator 20 (steps 2001 and 2002). Since it is ascertained that the user has reached the web page of the moving object, the web page with the moving object is transmitted to the page display unit 50 (step 2003).

After the display process for the moving object, and when the zero distance performer 60 has received the exit notification from the radar information generator 20 (step 2004), it is ascertained that the user has exited the web page of the moving object. Therefore, the moving object at step 2003 is deleted from the current web page (steps 2005 and 2006).

Further after the moving object has been displayed, and when the zero distance performer 60 receives, from the page display unit 50, a detection event (mouse click event) indicating the discovery of the moving object (steps 2007 and 2008) instead of the exit notification output by the radar information generator 20, the zero distance performer 60 ascertains that the user has found and obtained the moving object, and performs various processes, such as the acquisition and management of the information about the user and the shifting of the moving object (step 2009).

As is described above, when the target information provision system in this embodiment is applied for the user guidance system, since the user is permitted to search for the moving object, guidance is provided so that the user visits many sites in the site group, regardless of whether he or she is interested in the sites. Further, since the moving object appears in specific contents or at a site following a predetermined order, the user can be guided in a contract site group along a specific route.

Advantage of the Invention

As is described above, according to the present invention, when a user is browsing arbitrary contents, the user can be provided information for improving his or her ability to move to a desired site or contents.

The user can be guided to a specific site group by controlling the information that is provided.

1. A target information provision system comprising:
a target information manager for storing information concerning a predetermined target object present on a communication network;
an information generator for obtaining information concerning said target object from said target information manager, and for generating position information indicating the ease with which said target object can be reached; and
a target presenter for employing said position information generated by said information generator to furnish the location of said target object.

2. The target information provision system according to claim 1, wherein said information generator generates said position information concerning said target object based on the correlation between said target object and an object on a communication network from which information is acquired by a browser; and wherein said target presenter employs said position information generated by said information generator to provide a positional relationship between said target object and a current object.

3. The target information provision system according to claim 1, wherein said information generator calculates a distance between said target object and said current object based on a previously defined rule to specify a communication network distance, and generates position information that includes said obtained distance; and wherein said target presenter extracts said included distance from said position information and provides it as visually identified information.

4. The target information provision system according to claim 3, wherein, when the locations of objects on a communication network are represented by URLs, the distance between said objects is calculated based on the perspective in the hierarchical structure for storage locations of files of said objects represented by the URLs.

5. The target information provision system according to claim 3, wherein said distance between said objects on said communication network is calculated from the perspective applying to the categories of a rule for categorically arranging said objects.

6. The target information provision system according to claim 3, wherein the connection relationship existing between links to said objects on said communication network is employed to replace, with distance values, the minimum number of hops that is required to move from a predetermined object to another object.

7. A terminal device having a network connection function for accessing a communication network comprising:
a browser for browsing an object present on said communication network; and
a display unit for visually displaying a positional relationship indicating the ease of travel from a current object browsed by a browser to a predetermined target object present on said communication network.

8. The terminal device according to claim 7, wherein said display unit obtains, from a predetermined search engine, location information for said target object on said communication network and obtains, from said browser, location information for said current object on said communication network, and employs said location information for said target object and said current object to obtain the positional relationship relative to said objects.

9. The terminal device according to claim 8, wherein said display unit accesses a search site, and obtains, from a search engine at said search site, location information for a desired object on said communication network.

10. The terminal device according to claim 8, further comprising:
a search engine for accessing said communication network to obtain location information of an object present on the communication network,
wherein said display unit obtains, from a search engine, location information for a desired object on said communication network.

11. The terminal device according to claim 7, wherein a mark indicating an object is displayed at specific polar coordinates with said current object at the center, so that the positional relationship of said current object and said target object can be displayed.

12. The terminal device according to claim 7, wherein said distance between said target object and said current object is calculated based on said previously defined rule established to specify distances on said communication network, and a numeral indicating said distance is displayed.

13. The terminal device according to claim 7, wherein said distance between said target object and said current object is calculated based on said previously defined rule established to specify distances on said communication network, and a graph is displayed that shows the locus of a change in said distance between said current object and said target object.

14. An object position information provision method comprising the steps of:
registering, as a target object, an object that is present on a communication network and that matches a condition set by a user;
using a browser to browse said object present on said communication network; and
obtaining a positional relationship indicating the ease of travel from said current object to said target object, and providing information for said user describing said positional relationship.

15. The object position information provision method according to claim 14, wherein said step of obtaining said positional relationship of said objects and of providing information for said user describing said positional relationship includes the steps of:
obtaining location information for said target object on said communication network;
obtaining location information for said current object on said communication network; and
calculating a distance between said target object and said current object based on said location information for said objects and a previously defined rule that is employed for specifying distances on said communication network.

16. An object information provision system comprising:
a search site located on a communication network; and
a terminal device for accessing various sites, including said search site, via said communication network, and for browsing objects managed by said sites,
whereat, upon the receipt of a request from said terminal device, said search site returns, to said terminal device, location information for a predetermined site or object on said communication network, and
whereat said terminal device employs said location information for said predetermined site or said object received from said search site to submit a positional relationship indicating the ease of travel from a current object to said predetermined site or object.

17. The object information provision system according to claim 16, wherein said search site returns, to said terminal device, location information for a site or an object that is present on said communication network and that matches a previously established condition.

18. The object information provision system according to claim 16, wherein said terminal device transmits, with said request, location information for said current object on said communication network; and wherein said search site returns, to said terminal device, location information for a site or an object on said communication network, so that the distance on said communication network, between said site or object and said current object received from said terminal device, that is defined in accordance with a specific rule is equal to or smaller than a previously established value.

19. A computer program that permits a computer to perform:
a process for obtaining location information for a predetermined target object on a communication network; and
a process for employing said location information for said target object to generate information enabling the visual display of a positional relationship indicating the ease of travel from a current object to a target object.

20. A storage medium on which input means of a computer stores a computer-readable program that permits said computer to perform:
a process for obtaining location information for a predetermined object on a communication network; and
a process for employing said location information for said target object to generate information enabling the visual display of a positional relationship indicating the ease of travel from a current object to a target object.

21. A program transmission apparatus comprising:
storage means for storing a program that permits a computer to perform:
a process for obtaining location information for a predetermined target object on a communication network, and
a process for employing said location information for said target object to generate information enabling the visual display of a positional relationship indicating the ease of travel from a current object to a target object; and
transmission means for reading said program from said storage means and for transmitting said program.
